(19) United States
(12) Patent Application Publication
(10) Pub. No.: US 2009/0173189 A1
(43) Pub. Date: Jul. 9, 2009

(54) Adjustable socket

(75) Inventor: Larry Alford, Perth (AU)

Correspondence Address: CHARLES E. BAXLEY, ESQUIRE, 90 JOHN STREET, SUITE 309, NEW YORK, NY, 10038, US

(73) Assignee: Hand Tools International Taiwan Corp.

(21) Appl. No.: 12/008,021

(22) Filed: Jan. 8, 2008

(51) Int. Cl. B25B 13/18

(52) U.S. Cl. 81/128

(57) ABSTRACT

An adjustable socket includes a base having a channel for slidably attaching or engaging with two pawls which may slide relative to the base for adjusting the spacing distance between the pawls and for adjustably receiving and engaging with fasteners or tool members of different dimensions between the pawls and for allowing the tool members of different dimensions to be selectively rotated by the pawls and the base, and a retaining sleeve or device may be rotatably attached to the base and may retain the pawls at the adjusted spacing distance for allowing the tool members of different dimensions to be stably retained or engaged between the pawls.

### BACKGROUND OF THE INVENTION

1. Field of the Invention

The present invention relates to an adjustable socket, and more particularly to an adjustable socket including a structure for being easily manufactured and assembled and for being easily operated by the users.

2. Description of the Prior Art

Various kinds of typical adjustable sockets have been developed and comprise an adjustable structure for loosing or tightening or driving bolts, nuts, and other driven members or workpieces.

For example, U.S. Pat. No. 4,676,125 to Ardelean discloses one of the typical adjustable sockets comprising a hollow cylindrical casing having a number of uniformly spaced apart through openings for rotatably receiving gripping members.

However, the formation of the through openings in the hollow cylindrical casing may greatly reduce the strength of the hollow cylindrical casing. In addition, the sizes or dimensions or diameters of the bolts, nuts, and other driven members or workpieces that may be rotated or driven by the cylindrical casing are limited.

U.S. Pat. No. 5,644,959 to Howard discloses another typical adjustable or universal socket wrench comprising a bundle of engaging members having relatively large cross sectional area-to length ratios is slidably supported within a housing and arranged for engagement with a number of fastener components of different sizes or dimensions or diameters.

However, the formation or the provision of the engaging members may greatly increase the weight of the universal socket wrench, and the universal socket wrench may not be easily assembled.

U.S. Pat. No. 5,791,209 to Marks discloses a further typical adjustable or self-forming socket also comprising a number of retractable pins bundled or slidably supported within a housing and arranged for adjustably or selectively engaging with a number of fastener components of different sizes or dimensions or diameters or the like.

However, the formation or the provision of the retractable pins may greatly increase the weight of the self-forming socket, and the self-forming socket may not be easily or quickly assembled together by the workers.

U.S. Pat. No. 5,884,537 to Chen discloses a still further typical adjustable or universal socket tool comprising a housing having an oval inner peripheral surface, a core rotatably engaged in the housing for forming two curved slots, and two pairs of wedges slidably engaged in the curved slots of the housing and biased to engage with the core and for allowing the core to be rotated or driven by the housing.

However, the sizes or dimensions or diameters of the bolts, nuts, and other driven members or workpieces that may be rotated or driven by the cylindrical casing are limited.

U.S. Pat. No. 6,622,598 to Chang discloses a still further typical adjustable or universal sleeve barrel comprising a sleeve head rotatably engaged in a sleeve, and a number of pawls engaged between the sleeve and the sleeve head for adjustably engaging with the fastener components or the tool members of different sizes or dimensions or diameters.

However, the sizes or dimensions or diameters of the bolts, nuts, and other driven members or workpieces that may be rotated or driven by the cylindrical casing are also limited.

The present invention has arisen to mitigate and/or obviate the afore-described disadvantages of the conventional adjustable sockets.

### SUMMARY OF THE INVENTION

The primary objective of the present invention is to provide an adjustable socket including a structure for being easily manufactured and assembled and for being easily operated by the users.

In accordance with one aspect of the invention, there is provided an adjustable socket comprising a base including a channel formed therein, two pawls slidably attached to the base and limited to slide relative to the base for adjusting and determining a spacing distance between the pawls and for adjustably receiving and engaging with tool members of different dimensions between the pawls and for allowing the tool members of different dimensions to be selectively rotated by the pawls and the base, and a retaining device for retaining the pawls at the adjusted spacing distance therebetween, the adjustable socket includes a simplified structure for being easily manufactured and assembled and for being easily operated by the users.

The retaining device includes a sleeve rotatably attached to the base and having an oval-shaped inner peripheral surface formed therein for engaging with the pawls and for retaining the pawls at the adjusted spacing distance therebetween.

The sleeve includes an oval-shaped chamber formed therein and formed by the oval-shaped inner peripheral surface and having two narrowed end portions and wider side portions for engaging with the pawls.

The base includes at least one spring-biased projection engaged therein for engaging with the sleeve and for anchoring the sleeve to the base at a selected angular position. The base includes at least one cavity formed therein for receiving and engaging with the spring-biased projection.

The sleeve includes an inner gear formed therein for engaging with the spring-biased projection and for anchoring the sleeve to the base at the selected angular position.

The base includes a narrowed stud extended therefrom and having an outer diameter smaller than that of the base for forming an outer peripheral shoulder in the base, and the sleeve includes an inner peripheral shoulder formed therein for engaging with the outer peripheral shoulder of the base and for anchoring the sleeve to the base.

The pawls each include a tip portion for smoothly engaging with the oval-shaped inner peripheral surface of the sleeve and for allowing the sleeve to be smoothly rotated relative to the pawls and the base.

The pawls each include a flat surface formed therein for engaging with the tool members. The pawls each include a depression formed in the flat surface for engaging with the tool members.

The pawls each include a seat slidably engaged in the channel of the base for guiding the pawls to slide relative to the base. The pawls each include an orifice formed in the seat for engaging with a spring biasing member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view illustrating the operation of an adjustable socket in accordance with the present invention;

FIG. 2 is a front perspective view of the adjustable socket, in which a portion of the adjustable socket has been cut off for showing the inner structure of the adjustable socket;

FIG. 3 is a rear perspective view of the adjustable socket;

FIG. 4 is a cross sectional view of the adjustable socket taken along lines 4-4 of FIG. 2;

FIG. 5 is an end view of the base of the adjustable socket;

FIG. 6 is a cross sectional view of the adjustable socket taken along lines 6-6 of FIG. 5;

FIG. 7 is an end view of the sleeve of the adjustable socket;

FIG. 8 is a cross sectional view of the adjustable socket taken along lines 8-8 of FIG. 7;

FIG. 9 is a side view of the pawl of the adjustable socket;

FIG. 10 is an end view of the pawl of the adjustable socket; and

FIGS. 11, 12, 13, 14, 15 are end views illustrating the operation of the adjustable socket.

### DETAILED DESCRIPTION OF THE PREFERRED EMBODIMENT

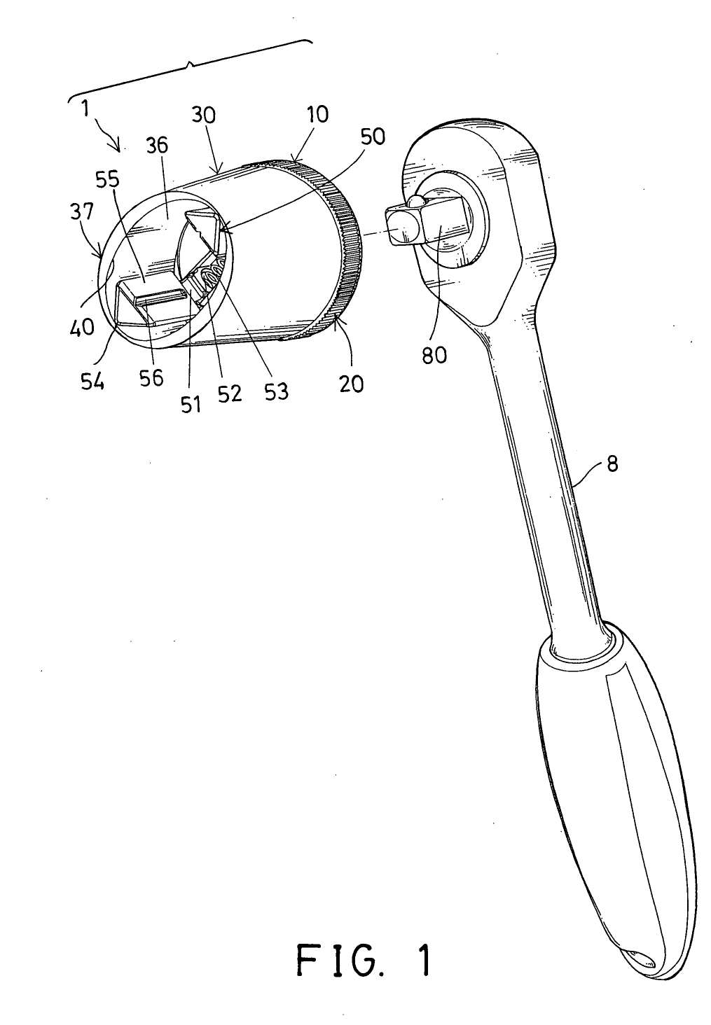

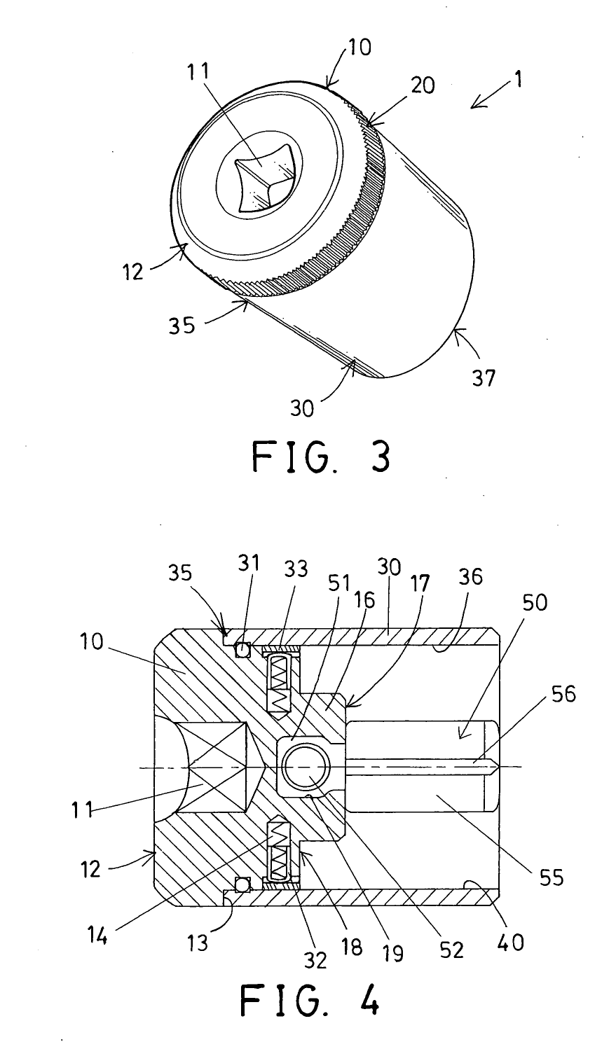

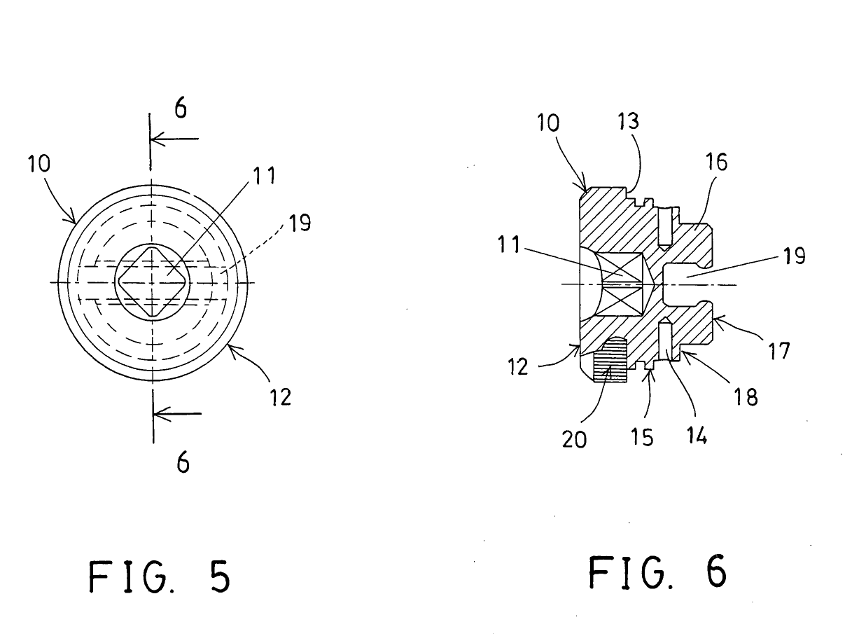

Referring to the drawings, and initially to FIGS. 1-4, an adjustable socket 1 in accordance with the present invention comprises a base 10 including an engaging hole 11 formed in one end or lower portion 12 thereof for engaging with such as a driving shank 80 of a driving tool 8 (FIG. 1) and for allowing the base 10 to be rotated or driven by the driving shank 80 of the driving tool 8, and including an outer peripheral shoulder 13 formed in the middle portion 15 thereof for rotatably engaging with an outer sleeve 30 and for anchoring the outer sleeve 30 to the base 10, and including a retaining ring 31 engaged between the base 10 and the outer sleeve 30 for rotatably securing the outer sleeve 30 to the base 10 and for limiting the outer sleeve 30 to rotate relative to the base 10 only, and for preventing the outer sleeve 30 from being disengaged from the base 10.

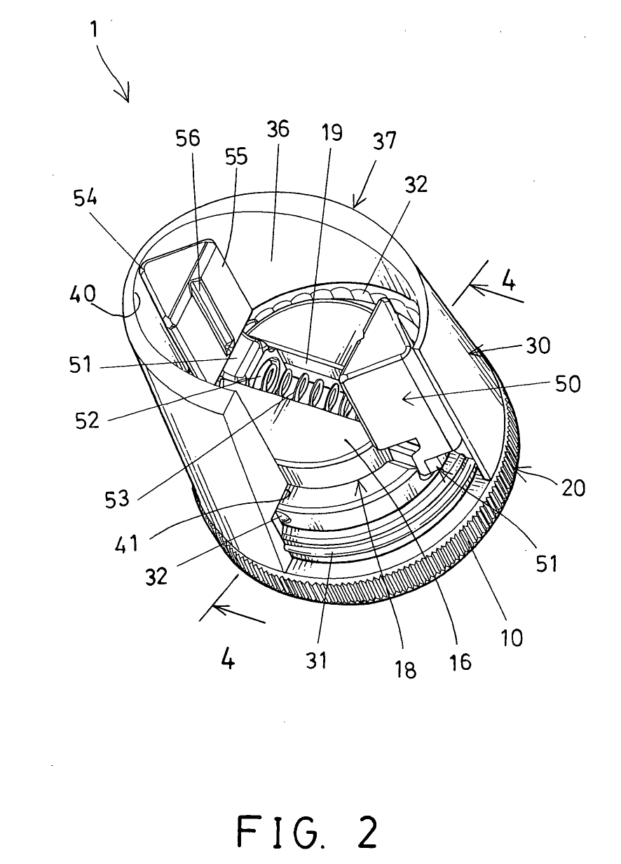

The base 10 further includes one or more cavities 14 laterally formed in the middle portion 15 thereof and each for receiving or engaging with a spring-biased projection 32 which is partially extended out of the middle portion 15 of the base 10 for engaging with the outer sleeve 30 and for anchoring the outer sleeve 30 to the base 10 at any selected angular position. It is preferable that the outer sleeve 30 includes a number of teeth or an inner gear 33 formed therein (FIGS. 2, 4, 11-13) for engaging with the spring-biased projections 32 and for stably anchoring the outer sleeve 30 to the base 10 at the selected angular position. In operation, the outer sleeve 30 may be rotated relative to the base 10 to any selected angular position, and the engagement of the spring-biased projections 32 with the inner gear 33 of the outer sleeve 30 may anchor and retain the outer sleeve 30 to the base 10 at the selected angular position.

The base 10 further includes a narrowed neck or stud 16 extended from the other end or upper portion 17 thereof (FIG. 6) and having an outer diameter smaller than that of the middle portion 15 of the base 10 for forming another outer peripheral shoulder 18 in the middle portion 15 of the base 10 and between the narrowed stud 16 and the middle portion 15 of the base 10, and further includes a channel 19 longitudinally and laterally formed in the other end or upper portion 17 of the base 10 and/or of the narrowed stud 16, and includes a serrated outer surface 20 for allowing the outer sleeve 30 to be easily rotated relative to the base 10 by the users. As shown in FIG. 8, the outer sleeve 30 may include a compartment 34 formed in one end or lower portion 35 thereof for rotatably receiving or engaging with the middle portion 15 of the base 10, and having the inner gear 33 formed in the inner peripheral portion of the compartment 34 of the outer sleeve 30 for engaging with the spring-biased projections 32.

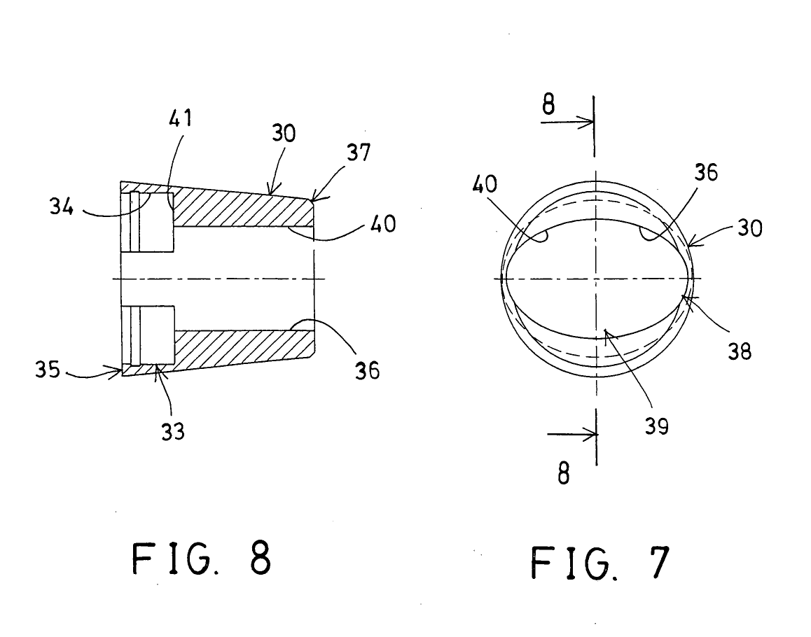

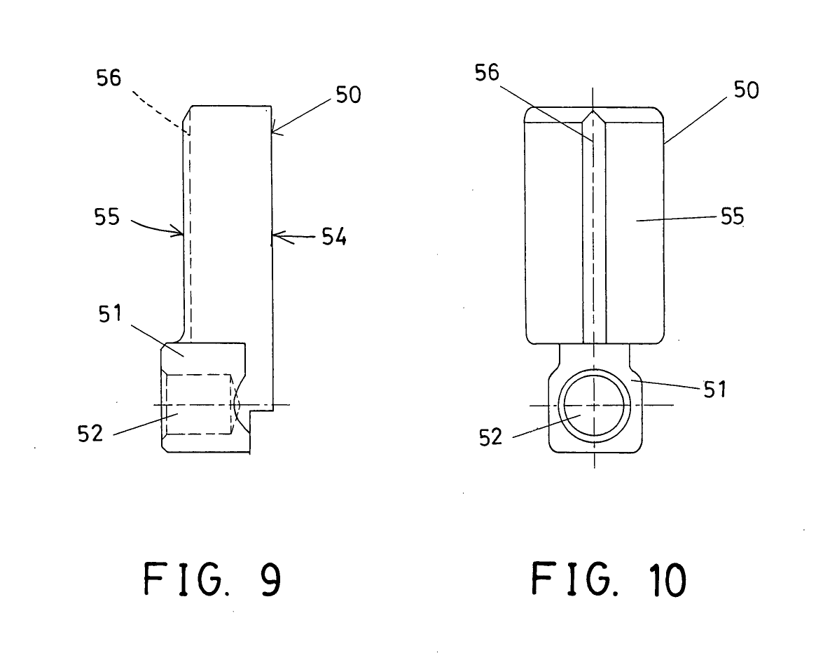

The outer sleeve 30 further includes an oval-shaped chamber 36 formed in the other end or upper portion 37 thereof (FIGS. 1-2, 7-8) and having two reduced or narrowed end portions 38 and two flattened or planar or wider side portions 39 and may include an oval-shaped inner peripheral surface 40 formed therein. A further inner peripheral shoulder 41 may be formed in the outer sleeve 30 and located between the compartment 34 and the oval-shaped chamber 36 of the outer sleeve 30 (FIGS. 2, 8) for rotatably receiving or engaging with the middle portion 15 of the base 10 and/or for rotatably engaging with the outer peripheral shoulder 18 of the base 10 and for further rotatably anchoring or securing the outer sleeve 30 to the base 10, and for further guiding or limiting the outer sleeve 30 to rotate relative to the base 10 only and for preventing the outer sleeve 30 from sliding longitudinally or axially relative to the base 10.

Two sliding members or followers or pawls 50 each include a lower portion or seat 51 slidably engaged in the channel 19 of the base 10 for guiding or limiting the pawls 50 to slide relative to the base 10, and each include an orifice 52 formed in each of the seats 51 for engaging with a spring biasing means or member 53 which may bias or force the pawls 50 to slide or to move away from each other and may bias or force the pawls 50 to engage with the oval-shaped inner peripheral surface 40 of the outer sleeve 30 (FIGS. 1-2, 11-15). As shown in FIGS. 1-2, 11-15, it is preferable that the pawls 50 each include a substantially triangular cross section having a rounded tip portion 54 for smoothly engaging with the oval-shaped inner peripheral surface 40 of the outer sleeve 30 and for allowing the outer sleeve 30 to be smoothly rotated relative to the pawls 50 and the base 10.

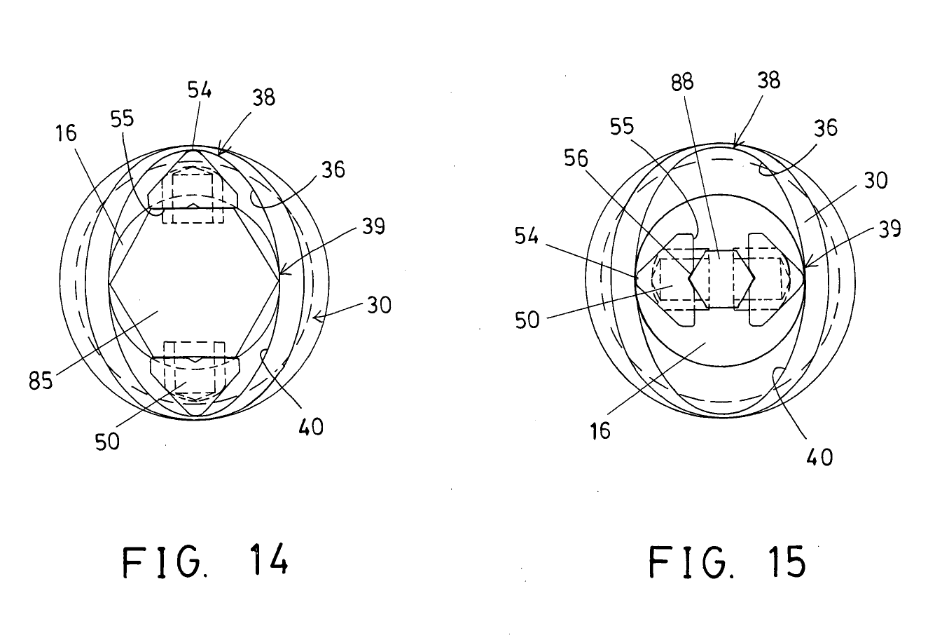

The pawls 50 each further include a flat surface 55 formed therein and located opposite to the rounded tip portion 54 for engaging with the fastener components or the tool members 85 (FIG. 14) and for allowing the fastener components or the tool members 85 to be selectively rotated or driven by the pawls 50 and the base 10, and each may further include a groove or depression 56 longitudinally formed therein for engaging with the other fastener components or the tool members 88 (FIG. 15) and for allowing the fastener components or the tool members 88 to be selectively rotated or driven by the pawls 50 and the base 10, and thus for allowing the fastener components or the tool members 85, 88 of different sizes or dimensions or diameters to be selectively rotated or driven by the pawls 50 and the base 10.

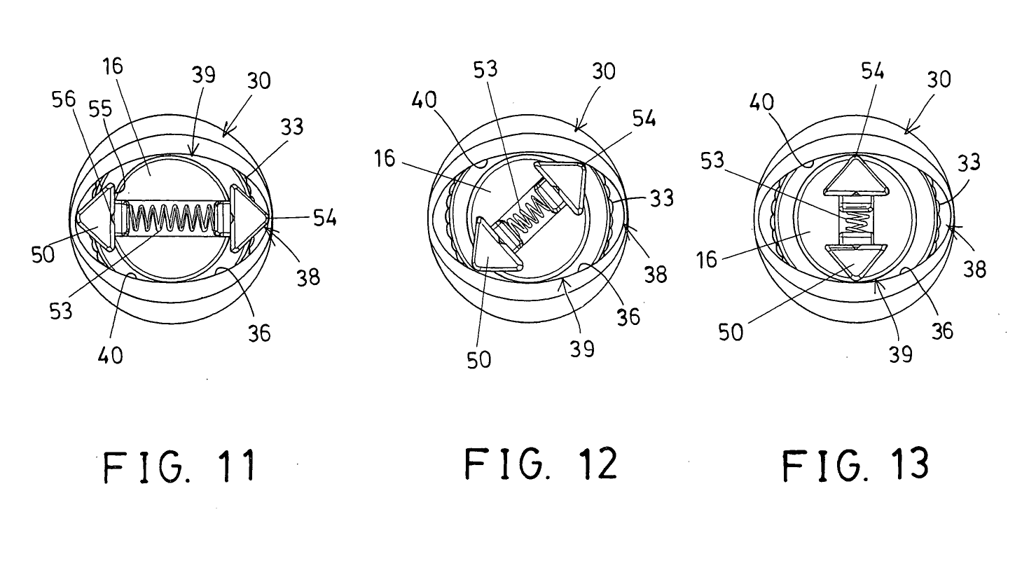

In operation, as shown in FIGS. 11-15, the outer sleeve 30 may be rotated relative to the base 10 by the users, and the pawls 50 may be forced to engage with the oval-shaped inner peripheral surface 40 of the outer sleeve 30 and may be forced to engage with either the narrowed end portions 38 (FIGS. 1-2, 11, 14), the flattened or planar or wider side portions 39 (FIGS. 13, 15), or the other portions of the oval-shaped inner peripheral surface 40 of the outer sleeve 30 (FIG. 12) in order to adjust and to determine the spacing distance between the pawls 50, and so as to adjustably receive or engage with the fastener components or the tool members 85, 88 of different sizes or dimensions or diameters. The engagement of the outer sleeve 30 with the pawls 50 or the outer sleeve 30 may be formed or acted as a retaining means or device for retaining or maintaining the pawls 50 at the predetermined or adjusted spacing distance.

It is to be noted that the typical adjustable sockets failed to provide two sliding members or followers or pawls 50 that are slidably attached or engaged with the base 10 for guiding or limiting the pawls 50 to slide relative to the base 10 and for adjusting or determining the spacing distance between the pawls 50, and for adjustably receiving or engaging with the fastener components or the tool members 85, 88 of different sizes or dimensions or diameters and thus for allowing the fastener components or the tool members 85, 88 of different sizes or dimensions or diameters to be selectively rotated or driven by the pawls 50 and the base 10. The retaining means or device or the outer sleeve 30 may retain or maintain the pawls 50 at the predetermined or adjusted spacing distance therebetween.

Accordingly, the adjustable socket in accordance with the present invention includes a structure for being easily manufactured and assembled and for being easily operated by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An adjustable socket comprising:
a base including a channel formed therein,
two pawls slidably attached to said base and limited to slide relative to said base for adjusting and determining a spacing distance between said pawls and for adjustably receiving and engaging with tool members of different dimensions between said pawls and for allowing the tool members of different dimensions to be selectively rotated by said pawls and said base, and
means for retaining said pawls at the adjusted spacing distance therebetween.

2. The adjustable socket as claimed in claim 1, wherein said retaining means includes a sleeve rotatably attached to said base and having an oval-shaped inner peripheral surface formed therein for engaging with said pawls and for retaining said pawls at the adjusted spacing distance therebetween.

3. The adjustable socket as claimed in claim 2, wherein said sleeve includes an oval-shaped chamber formed by said oval-shaped inner peripheral surface and having two narrowed end portions and wider side portions for engaging with said pawls.

4. The adjustable socket as claimed in claim 2, wherein said base includes at least one spring-biased projection engaged therein for engaging with said sleeve and for anchoring said sleeve to said base at a selected angular position.

5. The adjustable socket as claimed in claim 4, wherein said base includes at least one cavity formed therein for receiving and engaging with said at least one spring-biased projection.

6. The adjustable socket as claimed in claim 4, wherein said sleeve includes an inner gear formed therein for engaging with said at least one spring-biased projection and for anchoring said sleeve to said base at the selected angular position.

7. The adjustable socket as claimed in claim 2, wherein said base includes a narrowed stud extended therefrom and having an outer diameter smaller than that of said base for forming an outer peripheral shoulder in said base, and said sleeve includes an inner peripheral shoulder formed therein for engaging with said outer peripheral shoulder of said base and for anchoring said sleeve to said base.

8. The adjustable socket as claimed in claim 2, wherein said pawls each include a tip portion for engaging with said oval-shaped inner peripheral surface of said sleeve and for allowing said sleeve to be smoothly rotated relative to said pawls and said base.

9. The adjustable socket as claimed in claim 1, wherein said pawls each include a flat surface formed therein for engaging with the tool members.

10. The adjustable socket as claimed in claim 9, wherein said pawls each include a depression formed in said flat surface for engaging with the tool members.

11. The adjustable socket as claimed in claim 1, wherein said pawls each include a seat slidably engaged in said channel of said base for guiding said pawls to slide relative to said base.

12. The adjustable socket as claimed in claim 11, wherein said pawls each include an orifice formed in said seat for engaging with a spring biasing member.
